(19) United States
(12) Patent Application Publication
(10) Pub. No.: US 2005/0216895 A1
(43) Pub. Date: Sep. 29, 2005

(54) Method and apparatus for remote debugging of kernel and application software

(76) Inventor: Hieu Trung Tran, San Jose, CA (US)

Correspondence Address: HIEU TRUNG TRAN / VIOSOFT CORP., SUITE 203A, 2959 S. WINCHESTER BLVD, CAMPBELL, CA, 95008, US

(21) Appl. No.: 10/807,529

(22) Filed: Mar. 23, 2004

(51) Int. Cl. G06F 9/44

(52) U.S. Cl. 717/127

(57) ABSTRACT

A method and apparatus for debugging of OS kernel and applications software that does not require use of a hardware probe; can debug both user-mode programs and a significant body of the OS kernel code; allows the OS to continue servicing exceptions while debugging; leverages OS built-in device drivers for communicating devices to communicate with the host debugger; and can debug a production version of the OS kernel. When debugging is required, the running OS kernel dynamically loads a software-based debug agent on demand whereby such debug agent dynamically modifies the running production OS kernel code and data to intercept debugging traps and provide run-control. To provide debugging of loadable module, the debug agent implement techniques to intercept the OS module loading system call; set breakpoints in the loaded module initialization function; calculate the start address of the debugged module in memory; and asynchronously put the system under debug. By structuring command loop to execute in non-exception mode, and devising a process to transfer execution from the debug agent exception handler to the debug agent command loop and back, the debug agent can communicate with the host debugger using interrupt-driven input/output devices as well as allowing the system to service interrupts while under debug.

### CROSS-REFERENCE TO RELATED APPLICATIONS

Not Applicable

### FEDERALLY SPONSORED RESEARCH

Not Applicable

### FIELD OF INVENTION

This invention relates to tools for remote debugging. Particularly, the present invention relates to the method and apparatus for debugging kernel and application code running within an operating system on a remote computer.

### BACKGROUND OF THE INVENTION

An embedded system typically consists of one or more processors (“CPU”), and attached memory. Most embedded systems have hardware bus, and one or more input/output devices, called “peripheral devices”, coupled to the hardware bus. Embedded systems usually operate without human intervention, and many are part of larger systems. Modem embedded systems typically run an operating system (“OS”), on which one or more embedded programs execute. Embedded systems are sometimes referred to as “remote computer”, “embedded target”, “remote target”, or “target”; OS that runs on embedded target as “embedded OS”; and programs executing on embedded target as “embedded programs”.

Locating and correcting suspected defects or “bugs” in a computer program is a process known as “debugging”. A tool used to debug an embedded program is called a “remote debugger”, implying that such debugging tool and the debugged target program execute on different computers. The computer on which the debugger runs is called the “host computer”, or “host”. Debuggers generally provide two groups of functions: “access” and “run-control”. Access refers to the functions of the debuggers that read and write registers and memory of the debugged entity. Run-control refers to the functions of the debuggers that suspend the debugged entity at one or more execution points (“breakpoints”), resume execution, single step one instruction or source line, and step into, over, or out of function calls. On most processors, debuggers set breakpoints by writing a BREAK instruction at the break address, and directly or indirectly servicing the system exception that occurs as a result of the debugged entity executing such BREAK instruction. System exceptions consequential to debugging are called “debugging exceptions” or “debugging traps”.

The embedded OS services system traps and interrupts (collectively “exceptions”), and provides the application programmers with a programming interface (“API”) to synchronize access to shared resources, communicate with other programs, and interact with different types, classes, and variations of hardware and peripheral devices through common abstractions. The OS program image is sometimes referred to as the “kernel”. The OS kernel implements a majority, if not all, of its API calls as system calls (or “syscalls”). A user-mode program invokes a syscall by placing the specific API call opcode and proper argument(s), if any, on its program stack space, and executing a syscall machine instruction (such as the SWI instruction on ARM processors). The syscall machine instruction causes the processor to enter exception mode, wherein the corresponding exception handler uses the opcode to index into the “syscall table” and invoke the function referenced therein. Code that executes while the processor in exception mode is said to be executing under “exception context” or in “exception mode”, while code that do not is said to be executing under “non-exception context” or in “non-exception mode”. All user-space code, and the majority of OS kernel code run in non-exception mode. OS code that abstracts variations in a peripheral device is called a “device driver”. A device driver can be linked with the kernel at build time, or dynamically loaded while the OS is running. A dynamically loaded device driver is called a “loadable module”, or “module”. A module is loaded by a module loading utility program that runs in user-mode and invokes an OS syscall (“sys_init_module”) to load the module from persistent store into memory and start execution. A device driver can operate the hardware device in “poll-mode”, whereby changes in the device status are detected periodically by code executing in a loop (“polling code”). In most cases, most device drivers operate the hardware device in “interrupt-driven mode”, whereby changes in device status are signaled by external interrupts to the processor. Because most processors do not allow re-reentrancy of exception handling, code executing within exception context typically cannot directly or indirectly access or use hardware devices in interrupt-driven mode. When proper support is available from the processor, many OS's implement memory protection, allowing different programs to run simultaneously under the same memory address or range of addresses. Such memory addresses, called “virtual address”, are mapped by the OS and processor into available physical memory through a process called “address translation”. The OS performs address translation, in tandem with the processor hardware memory management unit (or “MMU”).

Remote debuggers can be used to debug processor interrupt handling code (“ISR”), non-exception kernel code, device drivers, and application programs executing as processes and threads, and collectively called “debugged entity”. The set of machine registers and memory contents that define the current states of execution is called the “execution context”. The execution context of a debugged entity defines that entity most recent state of execution.

The autonomous nature of embedded systems requires a controlling entity, called the “debug agent”, to function as an intermediary between the host and target system to facilitate debugging. A debug agent can be a hardware device (called “debugging probe”, or “hardware probe”), such as JTAG or ROM emulators that function as peripheral devices to the host debugger, and connected to the target system via special hardware debug port(s). Alternatively, a debug agent can be a software program that runs on the target system. Conventional debugging systems using debugging probes typically control the target through the target processor dedicated hardware debug interface. A limitation of hardware-assisted debugging systems is their inability to allow servicing of system exceptions by the target OS while the system is under host debugger's run-control. This limitation prevents hardware-assisted debugging systems from being used effectively in situations where the target system is expected to service exceptions within certain allowable time limits. Examples of side effects stemming from this limitation include: 1) network packets dropped causing time-out in client or server software, and 2) multimedia audio/video streams not being processed causing visible or audible delays or malfunctions within the system. Another limitation of hardware-assisted debugging systems is their inability to access the target virtual memory. Virtual addresses presented to the target by the hardware probe can not be translated by the target because such address translation is performed by the OS and the processor, which are both effectively halted while under the hardware probe's run-control. Alternatively, some hardware-assisted debugging systems perform translation by duplicating the translation logic of the OS and processor in the memory access code within the host debugger. Such implementations are complex and not portable among variations in OS's and processors supported by the debugging systems.

Conventional software-based debugging systems (such as those using REDBOOT, GDBSERVER, KGDB, or Viosoft VMON1) rely on the target resident debug agent to access and control debugged entities. Implementations of software-based debug agent comprise: “boot and debug monitor”, “kernel patch”, and “application debugging server”.

A boot monitor or “boot loader” typically resides in the target read-only memory (“ROM”), and executes on target power-up or reset. A boot loader performs a limited set of functionalities offered by an operating system, including servicing certain system exceptions and providing a simple command interface. Most if not all boot loaders provide a command for downloading programs, including an OS, via one of the target available input/output devices, and running such programs. Optionally, boot loaders such as CYGMON, REDBOOT, or VMON1 provide interfaces over various available communication channels between the host and target to facilitate remote debugging. Boot loaders that offer debugging interfaces or functionalities are called “debug monitors”. Debug monitors generally can't be used to debug programs such as an OS, which takes over servicing of system exceptions since the debug monitor looses run-control once such programs execute.

Kernel patch such as KGDB is a set of source code modifications (called “debugging patches”) to the kernel source code, or when the debugging patches already exist in the kernel source code, enabling them by setting the appropriate options at kernel image built time. When applied, debugging patches modify the OS kernel to intercept debugging traps and provide run-control. One limitation of debugging patches is that they present security holes in the OS if not removed or disabled when the debugged OS kernel is deployed. Alternatively, a version of the OS kernel can be built for debugging purposes. When the bugs are located and fixed, a production version of the same kernel with the debugging patches removed or disabled can be built for deployment. This approach is prone to error and time consuming, and furthermore does not allow for a production version of the OS kernel to be debugged. In addition, because current debug patches such as KGDB communicates with the host debugger under exception context, target peripheral devices used to communication with the host debugger must operate in poll mode.

Application debugging servers, such as GDBSERVER, are user-mode programs that provide a debugging server interface to the host debugger over various available communication channels between the host and target. Application debugging servers use an OS API (such as the Unix PTRACE or PROCFS API) to perform access and run-control of the debugged entity. The main limitation of application debugging servers is that they typically can only be used to debug user-mode programs.

Thus, a significant need exists for a debugging system that 1) does not require use of a hardware probe, 2) can debug both user-mode programs and a significant body of the OS kernel code, 3) allows the OS to continue servicing exceptions while debugging, 4) leverages OS built-in device drivers for communicating devices to communicate with the host debugger, and 5) can debug a production version of the OS kernel.

### SUMMARY OF THE INVENTION

The invention describes the method and apparatus directed at addressing the above shortcomings, disadvantages and problems, and will be understood by reading and studying the following specification.

One aspect of the invention is a method and apparatus for dynamically loading a software-based debug agent (or simply “debug agent”) on demand whereby such debug agent dynamically modifies the running production OS kernel code and data to intercept debugging traps and provide run-control.

A second aspect of the invention is a method and apparatus for debugging of loadable module consisting of: intercepting the OS module loading system call; setting breakpoints in the loaded module initialization function; calculating the start address of the debugged module in memory; and asynchronously putting the system under debug by fictitiously loading a benign module.

A third aspect of the invention is a method and apparatus for transferring execution from the debug agent exception handler to the debug agent command loop and back, ensuring that communication to the host debugger takes place while the command loop is under non-exception context.

### BRIEF DESCRIPTION OF THE DRAWINGS

FIG. 1 illustrates a block diagram of a target computer system consistent with the preferred embodiment.

FIG. 2 illustrates a flow diagram of the dynamic loading and execution of the debug agent.

FIG. 3 illustrates conceptual diagram of a debugging system apparatus consistent with the preferred embodiment.

FIG. 4 illustrates a block diagram of software components on the target consistent with the preferred embodiment.

FIG. 5 illustrates a block diagram of the OS kernel code and data image before and after loading of the debug agent.

FIG. 6 illustrates a sequence diagram of the interaction between the debug agent and host debugger at debug agent initialization time.

FIG. 7 illustrates a sequence diagram of the interaction among the debug agent trap handler, the debug agent command loop, and the host debugger at occurrence of a debugging trap.

FIG. 8 illustrates a sequence diagram of the interaction between the debug agent and host debugger to load symbol information of the debugged entity.

### PREFERRED EMBODIMENTS

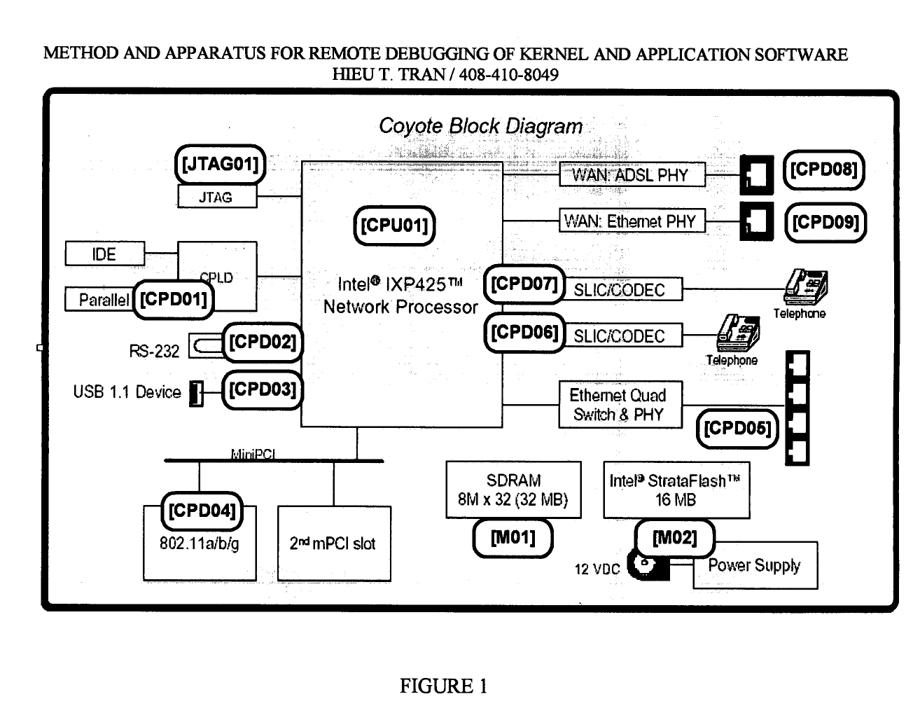

Turning to the Drawings, FIG. 1 illustrates a computer system consistent with the preferred embodiment. The computer system shown is a typical embedded computer board and includes at least one processor [CPU01]. Coupled to the processor are random access memory (“RAM”) [M01] and read-only memory (“ROM”) [M02]. Coupled to the processor are a number of input/output communicating devices [CPD01-CPD09] that are directly attached to the processor or through the hardware bus [B01]. Most, if not all of these communicating devices, can operate in either poll mode or interrupt-drive mode. The processor [CPU01] loads an operating system from ROM [M02] or remotely over one of the communicating devices [CPD01-CPD09] into RAM [M01] and executes the OS.

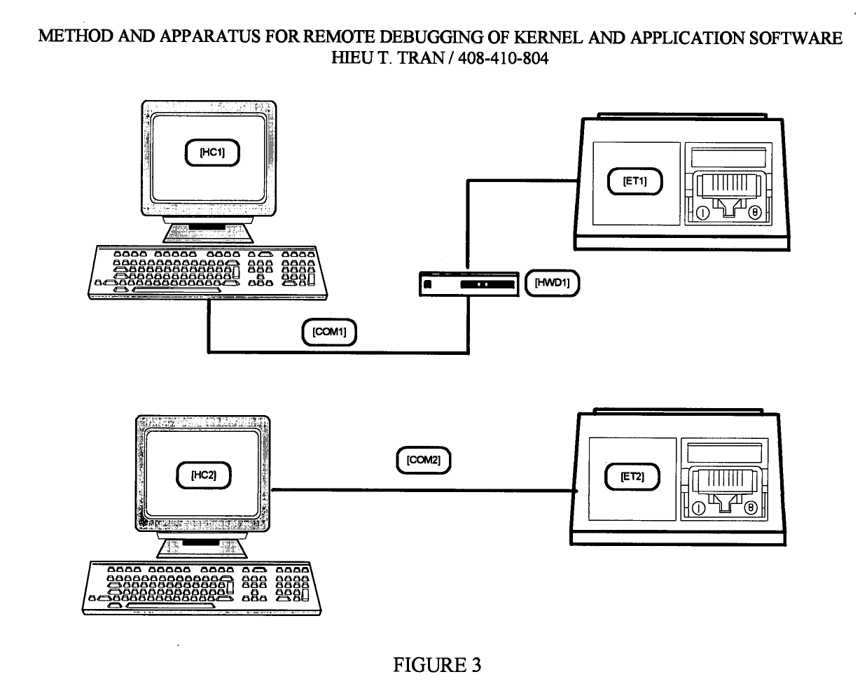

Referring to an embodiment illustrated in FIG. 3. In the preferred embodiment, the host computer [HC2] is connected to the target computer [ET2] via one of the target computer communicating devices [COM2]. Alternatively, the host computer [HC1] is connected to a debug probe [HWD1] via the debug probe's communicating device [COM1]. The debug probe, in turn, is connected to the target [ET1] via a special debug interface [JTAG1].

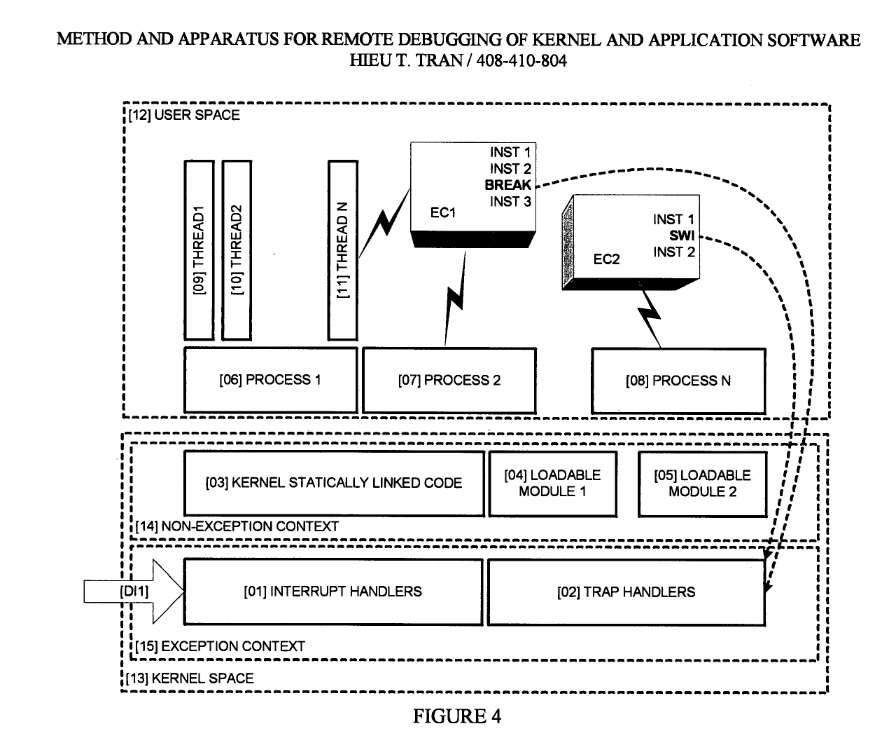

FIG. 4 illustrates a conceptual block diagram of the software components on the target consistent with the preferred embodiment. Target program code run under either user-space [12] or kernel-space [13]. Code that run under user-space, such as processes [06-08] and threads [09-11], don't have direct access to the processor, system hardware, or physical memory. In contrast, code that run under kernel space, which is almost exclusively all kernel code, directly access the processor, hardware, and memory. Kernel space code consists of code that runs under exception context [15] such as interrupts handlers [01] and trap handlers [02], and code that runs under non-exception context such as the kernel statically linked code [03] and loadable modules [04-05]. User-space program can cause the system to execute under the exception context by executing special instructions such as the BREAK instruction [EC0] used to implement breakpoints, or SWI instruction [EC1] used to invoke system call. The occurrence of external device interrupts [DI1] can also take the system into exception mode.

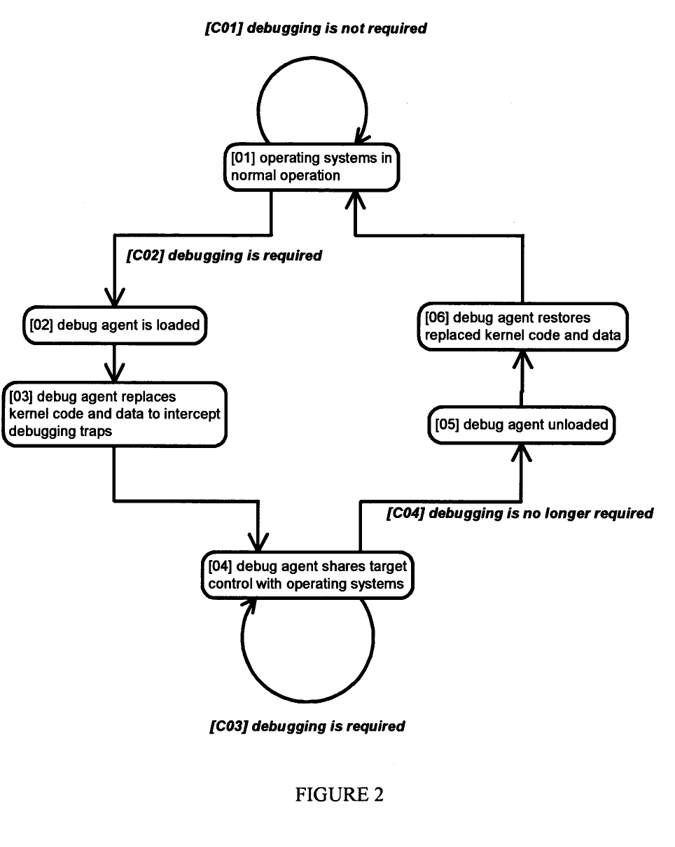

Referring to an embodiment illustrated in FIG. 2. In the preferred embodiment, the OS is executing normally [01] when no debugging is required [C01]. When debugging is required [C02], the debug agent image is dynamically loaded into memory and executed [02]. As part of its initialization process, the debug agent replaces selected code and data images of the running OS kernel in order to intercept system debugging traps [03]. Thereafter and while debugging is required [C03], the debug agent shares control of the target with the OS [04]. When debugging is no longer required [C04], the debug agent is unloaded [05]. As part of its exiting process, the debug agent restores previously replaced code and data images to their original values [06], returning the OS to normal operation [01].

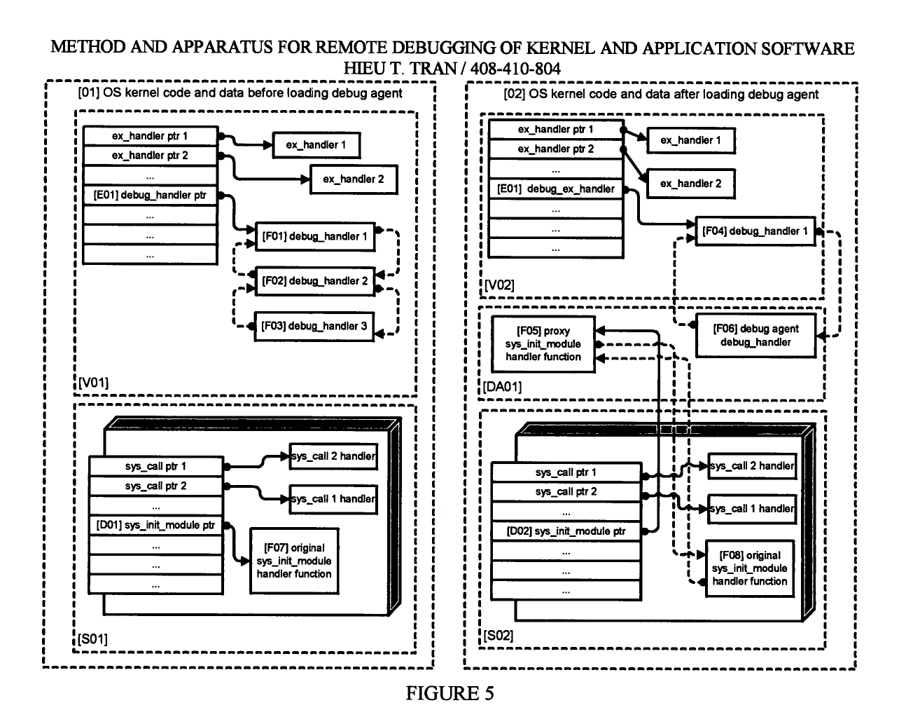

Referring to an embodiment illustrated in FIG. 5, wherein solid lines denote pointer references and dotted lines denote function calls. In the preferred embodiment, the OS kernel code and data before loading of the debug agent is shown in [01]. The exception vector [V01] is a table containing pointers to exception handling functions (“exception handlers”); each in-turn may directly or indirectly call one or more functions to handle the exception. The exception handlers and those functions that they invoked run under exception context. One or more exceptions may relate to debugging. Referring to entry [E01] of [01], which points to the debug exception handler [F01]. [F01] in turn may invoke other functions such as [F02] and [F03]. The syscall table [S01] contains pointers to functions that handle different system calls. One such system call, “sys_{—pl init}_module” [D01], is used to load and execute a loadable module. [D01] contains the pointer the OS sys_init_module handling function, also referred to as the original sys_init_module handler function [F07]. Turning to [02] which illustrates the OS kernel code and data after loading of the debug agent. During its initialization process, the debug agent modifies part of the OS debug handler [F04], to invoke the debug agent debug handler [F06], which resides within the debug agent code and data memory image [DA01]. This modification permits the debug agent to intercept debugging traps and implement run-control of debugged entities. In addition, the debug agent also modifies the syscall table [S02] so that the sys_init_module entry [D02] now points to the debug agent proxy sys_init_module handling function [F05].

The proxy sys_init_module function enables the debug agent to intercept module-loading occurrences. Responsive to determining that the loaded module is selected for debugging, the proxy sys_init_module function saves the pointer to the debugged module initialization function (“init_module”). This pointer is contained in the OS kernel data structure for the loadable module. The proxy sys_init_module function sets the value of this pointer in the OS kernel data structure to a predetermined value, usually 0, denoting the absence of init_module function for the loadable module. The proxy sys_init_module function then calls the original saved sys_init_module function to load the code and data image of the loadable module into memory, and sets a breakpoint at entry to the loadable module init_module function using a break code denoting the module inserting event. The proxy sys_init_module function then calls the loadable module init_module function, triggering the module inserting breakpoint, and invoking the debug agent debug trap handler. The debug agent trap handler, responsive to recognizing that the breakpoint is specific to module insertion, transfers control to the debug agent command loop, which sends information about the loaded module, and wais for further access requests or run-control requests from the host debugger.

Part of the information about the loaded module sent by the debug agent includes starting memory addresses of code and data blocks (or “section offsets”) of the debugged module. The host debugger uses section offsets to correctly build the symbol table necessary for the symbolic debugging of the debugged module. Section offsets comprises those for the “.bss”, “.text”, “.data”, and “.rodata” sections, as well as for other relevant code and data sections contained within the debugged module. In the preferred embodiment, the debug agent relies on section offsets being passed by the module loading program as part of the parameters to the sys_init_module syscall, which is subsequently intercepted by the debug agent, invoked to load the debugged module. Whenever an implementation of the module loading program that does not pass such information is used to load the debugged module, the debug agent alternatively sends only the addresses of the debugged module init_module and “cleanup_module” function, called when the module is unloaded. The host debugger calculates the address of the “.text” section by subtracting their relative addresses found in the debugged module symbol table from the specified address passed by the debug agent. With only the known address of the “.text” section, the host debugger is unable to correctly access global variables via symbol references as such references relate to the addresses of the “.bss”, “.data”, and “.rodata” sections. However, the host debugger can still provide full symbolic run-control based on the address of “.text”, and symbolically resolve references to local variables and function parameters as such parameters' addresses are relative to the known program frame pointer or stack pointer register.

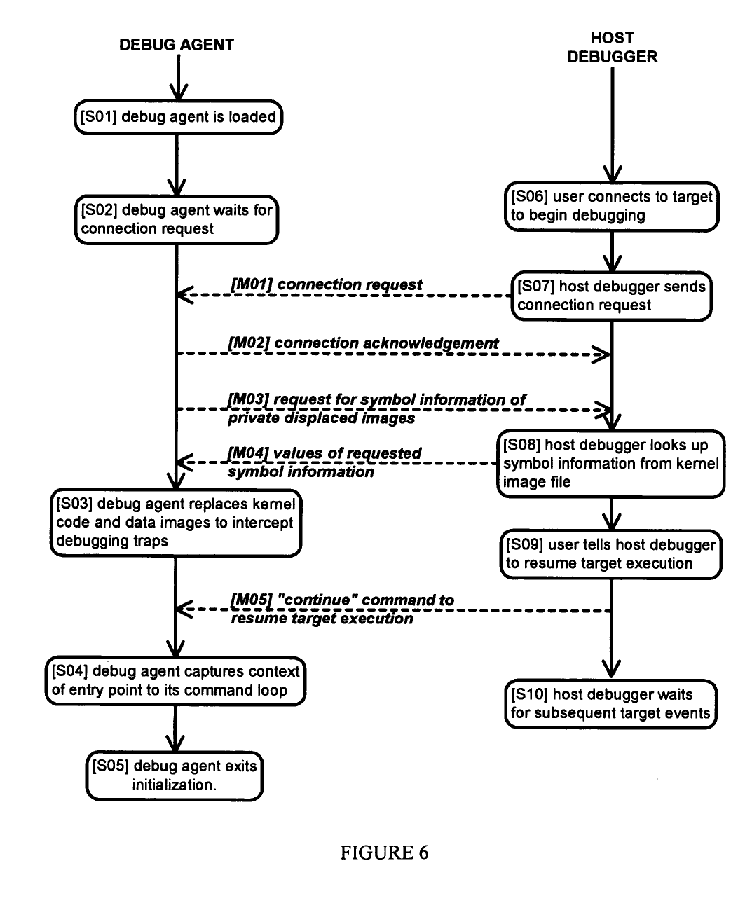

Replacing the OS kernel code and data, such as the exception handler function and the syscall entry, requires the debug agent to know precisely where in memory such code and data resides. When an object file contains unresolved references to kernel code and data entities is linked with the OS kernel image, the linker resolves all such references to their proper destinations within the image. When such object file is loaded dynamically, as in the case with loadable module, such references are resolved dynamically by the OS kernel dynamic loader. The OS kernel exports the symbol information for a subset of its code and data images that it expects to be referenced dynamically. For the debug agent, which is loaded dynamically to reference kernel code and data images whose symbols are not exported by the OS kernel, these symbols must be passed to the debug agent prior to being referenced. Referring to an embodiment illustrated in FIG. 6. In the preferred embodiment, the debug agent is loaded [S01], and waits for a connection request from the host debugger [S02]. The developer issues a command to the host debugger to begin debugging the target [S06]. The host debugger [S07] sends a connection request [M01] to the debug agent. The debug agent responds with a connection acknowledgement [M02], and further requests for the symbol information of those code and data that it will replace [M03]. The host debugger looks up such information from the OS kernel program image file, and responds [M04]. The debug agent uses the given symbols to replace selected OS kernel code and data as described above in order to intercept debugging traps [S03]. To resume the target execution, the host debugger issues a run-control command (such as the “continue” command) to the debug agent [M05]. The debug agent captures the execution context [S04] at the entry point into its command loop, whereby such context is used subsequently to re-enter the command loop from the debug agent debug trap handler, and exits its initialization flow [S05]. The host debugger wais for subsequent target events, such as breakpoints or module loading, to occur. Alternatively, when the symbol image file of the OS kernel is not available, or is out of date with the running OS kernel, such information can be passed as parameters to the module loading program, and subsequently to the loaded debug agent module.

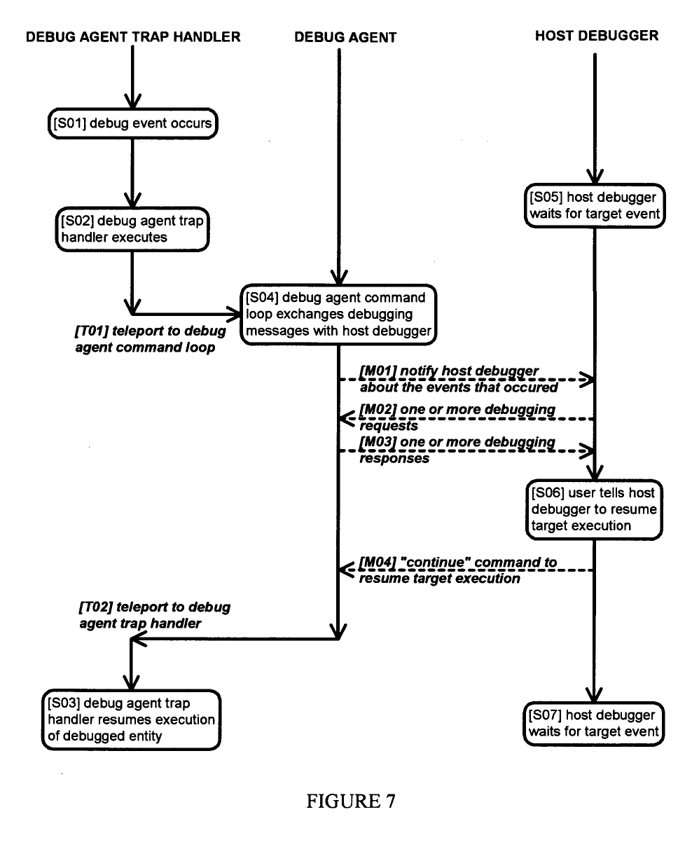

Referring to an embodiment in FIG. 7 illustrating the interaction among the debug agent trap handler, the debug agent command loop, and the host debugger at occurrence of a debugging trap. When a debugging trap, such as a breakpoint, occurs [S01], the OS trap handler saves the system context at trap occurrence into the context saved area, and invokes the debug agent trap handler ([F06], FIG. 5). The debug agent trap handler saves the system context in the context saved area, and replaces it with the context of the entry point to the debug agent command loop, captured during initialization ([S04], FIG. 6). The debug agent sets a global variable (“STATE”) to denote the occurrence of the debugging trap, and executes the processor exception return instruction (such as the “IRET” instruction on MIPS processors) to resume system execution to the destination, effectively the entry point to the command loop, specified by the current contents of the context saved area. The process of transferring control from the debug agent trap handler to the command loop [T01] and back [T02] is also referred to as “teleportation”. The debug agent loop responds to one or more access requests [M01-M03] from the host debugger while executing under non-exception context. Responsive to a run-control request from the host debugger [M04], the debug agent loop sets the STATE variable to indicate to the debug agent trap handler is occurring. The debug agent then executes an instruction, such as the BREAK instruction or an illegal instruction that causes the system to enter exception mode. The BREAK code or illegal opcode that accompanies such instruction also denote teleportation. Upon invocation, and responsive to determining that the executed instruction and the STATE variable both denote teleportation, the debug agent trap handler restores the previously saved context of the debugged entity at trap occurrence into the context saved area, and executes the processor exception return instruction to resume execution of the debugged entity [S03].

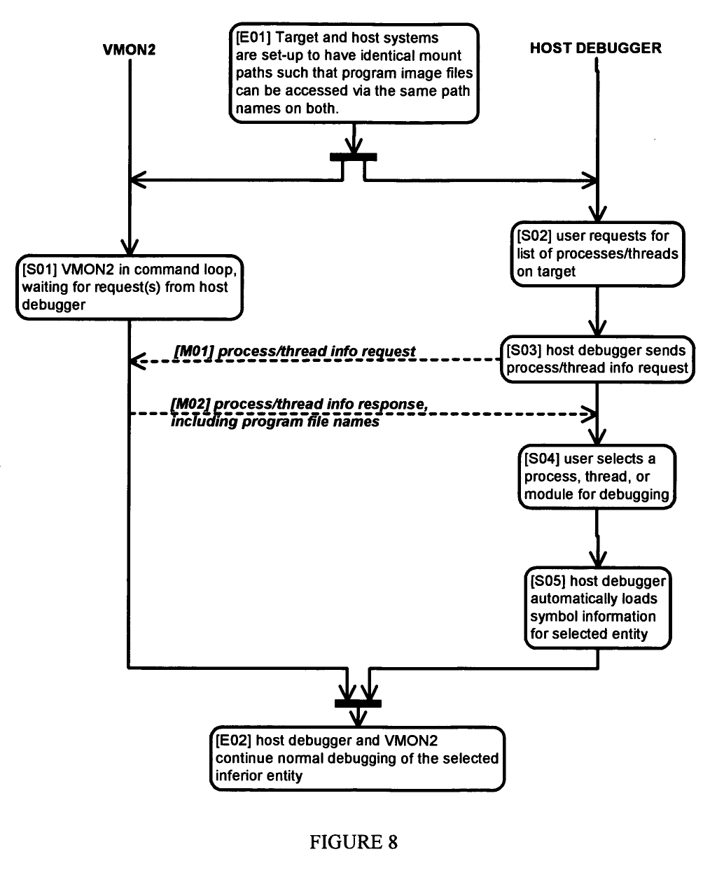

The debugging system of this invention allows the programmer to view the list of running program entities, such as processes and threads, on the target, and to select one or more for debugging. When a running entity is selected for debugging, its symbol table must be read and processed by the host debugger. Referring to an embodiment in FIG. 8 illustrating the interaction between the debug agent and the host debugger to automatically load the symbol table of such entities. At debugging setup time [E01], the target and host computer are configured to have identical mount paths wherein image files of running program entities can be accessed via the same pathnames on both computers. During debugging when the debug agent command loop is servicing one or more access requests [S01] from the host debugger, the host debugger requests to view a list of running program entities [S03]. The debug agent responds with a list of such entities, along with the full pathnames of their program image files [M02]. The debug user selects a particular entity for debugging [S04], causing the host debugger to load the debugging symbols from the selected entity program image file [S05]. Because such program image file can be accessed using the same pathname specified in [M02], no additional input or specification from the debug user is required necessary for the host debugger to locate such program image file on the host system.

Other modifications to the system and method described above will be apparent to one of ordinary skill in the art. Therefore, the invention lies solely in the claims hereinafter appended.

1. A method of debugging a remote computer, comprising:
running a debugger on a host computer;
running an operating system on the target computer;
when debugging is required, loading a debug agent from persistent store into memory and executing the debug agent;
executing initialization code of said debug agent, wherein replacing selected OS kernel code and data that are referenced, accessed, and otherwise used in the processing of debugging traps by the OS kernel, and whereas said replaced code and data reside in or reference to said debug agent code and data images in memory;
while the target is being debugged, the debug agent intercepting and processing one or more processor debugging traps generated;
when debugging is no longer required, unloading the debug agent, wherein restoring replaced OS kernel and data to original values.

2. The method of claim 1, wherein replaced OS code and data comprising:
a. private code and data, which are accessible only to references within the OS kernel program image;
b. exported code and data, which are accessible to references outside and within the OS kernel program image;
further wherein said references comprising:
c. one or more application program codes via system calls;
d. one or more loadable modules or device drivers via exported OS kernel interfaces.

3. The method of claim 1, wherein processing of said debugging traps comprising:
a. invoking the OS kernel private or exported functions by the debug agent;
b. accessing the OS kernel private or exported variables by the debug agent.

4. The method of claim 1, further comprising specifying addresses of OS kernel private code and data to the debug agent by at least one of the steps, comprising:
a. passing messages from host debugger at connect time to the debug agent;
b. passing parameters to the module loading program invoked to load the module.

5. The method of claim 1, wherein the debug agent program image is compiled or linked as code to be dynamically loaded and executed by the OS,
a. wherein the debugged program code executing in a non-exception context,
b. wherein the debugged program code comprising: one or more dynamically loaded or statically linked device drivers; and one or more application programs executing as one or more processes and threads;
c. further wherein non-exception context excludes the processor traps and interrupt handler context.

6. The method of claim 1, wherein said debugging traps are generated by an event from the selected one of:
a. executing a processor BREAK instruction;
b. executing an invalid instruction;
c. executing an instruction causing data access failure;
d. generating any device interrupts or processor traps causing the processor to enter exception context.

7. A method of intercepting the OS loadable module loading system call, comprising:
a. running a debug agent on the target system;
b. saving an entry in the OS syscall table pointing to a sys_init_module function, which services the OS module loading system call;
c. replacing said entry with a pointer to a proxy sys_init_module function residing in the debug agent memory image;
responsive to system call to load the loadable module by the loading utility program, executing the steps comprising:
d. invoking said proxy sys_init_module function via said replacement;
e. responsive to determining that said module has been selected for debugging, initiating debugging of the loadable module by the said proxy sys_init_module function.

8. The method of claim 7, further comprising debugging of an init_module function that is specific to and part of said loadable module, wherein said init_module function is normally invoked by the OS sys_init_module function after the loadable module image is loaded in memory, comprising the steps:
a. saving the pointer to the debugged module init_module function, whereas said pointer is part of the OS kernel data structure for the loadable module;
b. setting said pointer in the OS kernel data structure to a predetermined value denoting the absence of the init_module function for the loadable module;
c. calling the original saved sys_init_module function to load the code and data image of loadable module into memory;
d. setting a breakpoint at entry to the loadable module init_module function using a break code denoting the module inserting event;
e. invoking the loadable module init_module function, triggering said module inserting breakpoint, and invoking the debug agent debugging trap handler to effect debugging of the module.

9. The method of claim 7, further comprising calculating the start address of the loaded module, whenever such information is not available, comprising the steps:
a. notifying the host debugger that the debugged module is loaded, passing the addresses of the module init_module and cleanup_module functions, wherein the OS normally invokes said init_module function after the debugged module is loaded in memory, and further wherein the OS normally invokes said cleanup_module function before the debugged module is unloaded from memory, and whereas a module may have a selected one of one, none, or both init_module and cleanup_module functions specified;
b. responsive to module loading notification, calculating the absolute value of the start address of the in-memory program code area by offsetting the provided addresses of the init_module and cleanup_module functions from their respective relative addresses contained in the symbol table of the debugged module program image file;
c. comparing results of calculation based on each address for validation.

10. The method of claim 9, further comprising:
a. calculating the start address using one such function address available;
b. failing to provide symbolic debugging of the module if none is available.

11. The method of claim 7, further comprising asynchronously putting the target system under debug, comprising the steps:
a. configuring the host debugger to debug a benign module, which does nothing when loaded and unloaded;
b. loading the benign module when the target needs to be debugged;
c. unloading the benign module when resuming the target execution.

12. A method for transferring execution flow from the debug agent exception handler to and from the debug agent command loop after the occurrence of a debugging trap, comprising:
a. prior to the debugging trap occurrence, the debug agent capturing the execution context at the destination within the debug agent command loop;
b. saving of debugged entity context at trap occurrence in the context saved area and invoking the debug agent trap handler;
c. the debug agent trap handler saving and replacing the contents of the context saved area with said captured context at the destination;
d. the debug agent trap handler executing the exception return code to resume system execution to the specified destination within the debug agent command loop, whereas said specified destination context is stored in the context saved area;
e. the debug agent responding to one or more access requests from the host debugger;
the debug agent, responsive to a run-control request, performing steps comprising:
f. setting a global variable to a value denoting transference of command loop to trap handler, whereas such variable is accessible to debug agent command loop and debug agent trap handler;
g. executing an instruction causing the system to enter exception mode, wherein said instruction is a selected one of: a BREAK instruction or an illegal instruction, further wherein the BREAK code or the illegal instruction opcode denotes transference;
h. the system invoking the debug agent trap handler on entrance to exception mode;
responsive to determining that both the value of the global variable and the break code or the illegal instruction opcode denotes transference, the debug agent trap handler resuming execution to the debugged entity, comprising the steps:
i. restoring original execution context of the debugged entity to the context saved area;
j. executing the exception return code, resuming system execution to the destination at or near the point of the debugging trap occurrence in the debugged entity.

13. The method of claim 12, wherein the debug agent exception handler executes under system exception context and the debug agent command loop executes under system non-exception context.

14. The method of claim 12, further comprising communicating with the remote host debugger from the debug agent command loop, comprising the steps:
a. at debug agent initialization time, establishing a socket connection to the host debugger via available networking devices on the target;
b. exchanging debugging messages with the host debugger by invoking OS kernel send and receive functions from the debug agent command loop;
wherein said network devices operate in interrupt-driven mode via the OS kernel built-in device drivers, further wherein network devices consisting: wired and wireless Ethernet, serial, firewire, parallel, and USB devices.

15. The method of claim 12, further comprising communicating with the remote host debugger from the debug agent command loop, comprising the steps:
a. connecting a hardware-assisted debugging probe to the target computer;
b. connecting the host computer to the hardware-assisted debugging probe;
c. exchanging debugging messages by writing and reading dedicated memory regions on the target computer accessible to both the host debugger and the debug agent command loop;
wherein said hardware-assisted debugging probe consisting: JTAG emulator, or ROM emulator.

16. An apparatus comprising:
a target computer, comprising one or more processors;
a memory coupled to the processor;
a hardware bus coupling the processor and one or more peripheral devices;
one or more communicating peripheral devices coupled to the hardware bus;
an operating system running on the processor;
one or more programs, each residing in memory and executing on the processor as one or more processes or threads;
one or more device driver drivers, each loaded by the OS on demand;
a host computer, connecting to the target computer via communicating peripheral devices;
a host debugger executing on the host computer;
a debug agent, loaded by the OS on demand, residing in memory and executing on the target computer, wherein:
a. said debug agent is loaded from persistent store into memory and executed when debugging is required;
b. said debug agent initialization code replacing selected OS kernel code and data that are referenced, accessed, and otherwise used in the processing of debugging traps by the OS kernel, and whereas said replaced code and data reside in or reference to said debug agent code and data images in memory;
c. while the target is under debug, said debug agent intercepting and processing one or more processor debugging traps generated;
d. unloading the debug agent, wherein restoring replaced OS kernel and data to original values when debugging is no longer required.

17. The apparatus of claim 16, wherein replaced OS code and data comprising:
a. private code and data, which are accessible only to references within the OS kernel program image;
b. exported code and data, which are accessible to references outside and within the OS kernel program image; further wherein said references comprising:
c. one or more application program codes via system calls;
d. one or more loadable modules or device drivers via exported OS kernel interfaces.

18. The apparatus of claim 16, wherein processing of said debugging traps comprising:
a. invoking the OS kernel private or exported functions by the debug agent;
b. accessing the OS kernel private or exported variables by the debug agent.

19. The apparatus of claim 16, wherein the debug agent specifying of OS kernel private code and data to the debug agent by at least one of the steps, comprising:
a. passing messages from host debugger at connect time to the debug agent;
b. passing parameters to the module loading program invoked to load the module.

20. The apparatus of claim 16, wherein the debug agent program image is compiled or linked as code to be dynamically loaded and executed by the OS,
a. wherein the debugged program code executing in a non-exception context,
b. wherein the debugged program code comprising: one or more dynamically loaded or statically linked device drivers; and one or more application programs executing as one or more processes and threads;
c. further wherein non-exception context excludes the processor traps and interrupt handler context.

21. The apparatus of claim 16, wherein said debugging traps are generated by an event from the selected one of:
a. executing a processor BREAK instruction;
b. executing an invalid instruction;
c. executing an instruction causing data access failure;
d. generating any device interrupts or processor traps causing the processor to enter exception context.

22. The apparatus of claim 16, wherein the debug agent intercepting the OS loadable module loading system call, comprising:
a. saving an entry in the OS syscall table pointing to a sys_init_module function, which services the OS module loading system call;
b. replacing said entry with a pointer to a proxy sys_init_module function residing in the debug agent memory image;
responsive to system call to load the loadable module by the loading utility program, executing the steps comprising:
c. invoking said proxy sys_init module function via said replacement;
d. responsive to determining that said module has been selected for debugging, initiating debugging of the loadable module by the said proxy sys_init_module function.

23. The apparatus of claim 22, further wherein the debug agent debugging of an init_module function that is specific to and part of said loadable module, wherein said init_module function is normally invoked by the OS sys_init_module function after the loadable module image is loaded in memory, comprising the steps:
a. saving the pointer to the debugged module init_module function, whereas said pointer is part of the OS kernel data structure for the loadable module;
b. setting said pointer in the OS kernel data structure to a predetermined value denoting the absence of the init_module function for the loadable module;
c. calling the original saved sys_init_module function to load the code and data image of loadable module into memory;
d. setting a breakpoint at entry to the loadable module init_module function using a break code denoting the module inserting event;
e. invoking the loadable module init_module function, triggering said module inserting breakpoint, and invoking the debug agent debugging trap handler to effect debugging of the module.

24. The apparatus of claim 22, further wherein the debug agent calculating the start address of the loaded module, whenever such information is not available, comprising the steps:
a. notifying the host debugger that the debugged module is loaded, passing the addresses of the module init_module and cleanup_module functions, wherein the OS normally invokes said init_module function after the debugged module is loaded in memory, and further wherein the OS normally invokes said cleanup_module function before the debugged module is unloaded from memory, and whereas a module may have a selected one of one, none, or both init_module and cleanup_module functions specified;
b. responsive to module loading notification, calculating the absolute value of the start address of the in-memory program code area by offsetting the provided addresses of the init_module and cleanup_module functions from their respective relative addresses contained in the symbol table of the debugged module program image file;
c. comparing results of calculation based on each address for validation.

25. The apparatus of claim 24, further wherein the debug agent:
a. calculating the start address using one such function address available;
b. failing to provide symbolic debugging of the module if none is available.

26. The apparatus of claim 22, further wherein the debug system asynchronously putting the target system under debug, comprising the steps:
a. configuring the host debugger to debug a benign module, which does nothing when loaded and unloaded;
b. loading the benign module when the target needs to be debugged;
c. unloading the benign module when resuming the target execution.

27. The apparatus of claim 16, wherein the debugging system transferring of execution flow from the debug agent exception handler to and from the debug agent command loop after the occurrence of a debugging trap, comprising:
a. prior to the debugging trap occurrence, the debug agent capturing the execution context at the destination within the debug agent command loop;
b. saving of system context at trap occurrence in the context saved area and invoking the debug agent trap handler;
c. the debug agent trap handler saving and replacing the contents of the context saved area with said captured context at the destination;
d. the debug agent trap handler executing the exception return code to resume system execution to the specified destination within the debug agent command loop, whereas said specified destination context is stored in the context saved area;
e. the debug agent responding to one or more access request from the host debugger;
the debug agent, responsive to a run-control request from the host debugger, performing steps comprising:
f. setting a global variable to a value denoting transference of command loop to trap handler, whereas such variable is accessible to debug agent command loop and debug agent trap handler;
g. executing an instruction causing the system to enter exception mode, wherein said instruction is a selected one of: a BREAK instruction or an illegal instruction, further wherein the BREAK code or the illegal instruction opcode denotes transference;
h. the system invoking the debug agent trap handler on entrance to exception mode;
responsive to determining that both the value of the global variable and the break code or the illegal instruction opcode denotes transference, the debug agent trap handler resuming execution to the debugged entity, comprising the steps:
i. restoring original execution context of the debugged entity to the context saved area;
j. executing the exception return code, resuming system execution to the destination at or near the point of the debugging trap occurrence in the debugged entity.

28. The apparatus of claim 27, wherein the debug agent exception handler executes under system exception context and the debug agent command loop executes under system non-exception context.

29. The apparatus of claim 27, wherein communicating with the remote host debugger from the debug agent command loop comprising the steps:
a. at debug agent initialization time, establishing a socket connection to the host debugger via available networking devices on the target;
b. exchanging debugging messages with the host debugger by invoking OS kernel send and receive functions from the debug agent command loop;
wherein said network devices operate in interrupt-driven mode via the OS kernel built-in device drivers, further wherein network devices consisting: wired and wireless Ethernet, serial, firewire, parallel, and USB devices.

30. The apparatus of claim 27, wherein communicating with the remote host debugger from the debug agent command loop comprising the steps:
a. connecting a hardware-assisted debugging probe to the target computer;
b. connecting the host computer to the hardware-assisted debugging probe;
c. exchanging debugging messages by writing and reading dedicated memory regions on the target computer accessible to both the host debugger and the debug agent command loop;
wherein said hardware-assisted debugging probe consisting: JTAG emulator, or ROM emulator.

31. A program product comprising:
a debugger running on a host computer;
a debug agent, when loaded from persistent store into memory and executed;
comprising the steps:
a. executing the debug agent initialization, wherein replacing selected OS kernel code and data that are referenced, accessed, and otherwise used in the processing of debugging traps by the OS kernel, and whereas said replaced code and data reside in or reference to said debug agent code and data images in memory;
b. while the target is being debugged, intercepting and processing one or more processor debugging traps generated;
c. when debugging is no longer required, unloading and restoring replaced OS kernel and data to original values.

32. The program product of claim 31, wherein replaced OS code and data comprising:
a. private code and data, which are accessible only to references within the OS kernel program image;
b. exported code and data, which are accessible to references outside and within the OS kernel program image;
further wherein said references comprising:
c. one or more application program codes via system calls;
d. one or more loadable modules or device drivers via exported OS kernel interfaces.

33. The program product of claim 31, wherein processing of said debugging traps comprising:
a. invoking the OS kernel private or exported functions by the debug agent;
b. accessing the OS kernel private or exported variables by the debug agent.

34. The program product of claim 31, further comprising specifying addresses of OS kernel private code and data to the debug agent by at least one of the steps, comprising:
a. passing messages from host debugger at connect time to the debug agent;
b. passing parameters to the module loading program invoked to load the module.

35. The program product of claim 31, wherein the debug agent program image is compiled or linked as code to be dynamically loaded and executed by the OS,
a. wherein the debugged program code executing in a non-exception context,
b. wherein the debugged program code comprising: one or more dynamically loaded or statically linked device drivers; and one or more application programs executing as one or more processes and threads;
c. further wherein non-exception context excludes the processor traps and interrupt handler context.

36. The program product of claim 31, wherein said debugging traps are generated by an event from the selected one of:
a. executing a processor BREAK instruction;
b. executing an invalid instruction;
c. executing an instruction causing data access failure;
d. generating any device interrupts or processor traps causing the processor to enter exception context.

37. A program product for intercepting the OS loadable module loading system call, comprising:
a. running a debug agent on the target system;
b. saving an entry in the OS syscall table pointing to a sys_init_module function, which services the OS module loading system call;
c. replacing said entry with a pointer to a proxy sys_init_module function residing in the debug agent memory image;
responsive to system call to load the loadable module by the loading utility program, executing the steps comprising:
d. invoking said proxy sys_init_module function via said replacement;
e. responsive to determining that said module has been selected for debugging, initiating debugging of the loadable module by the said proxy sys_init_module function.

38. The program product of claim 37, further comprising debugging of an init_module function that is specific to and part of said loadable module, wherein said init_module function is normally invoked by the OS sys_init_module function after the loadable module image is loaded in memory, comprising the steps:
a. saving the pointer to the debugged module init_module function, whereas said pointer is part of the OS kernel data structure for the loadable module;
b. setting said pointer in the OS kernel data structure to a predetermined value denoting the absence of the init_module function for the loadable module;
c. calling the original saved sys_init_module function to load the code and data image of loadable module into memory;
d. setting a breakpoint at entry to the loadable module init_module function using a break code denoting the module inserting event;
e. invoking the loadable module init_module function, triggering said module inserting breakpoint, and invoking the debug agent debugging trap handler to effect debugging of the module.

39. The program product of claim 37, further comprising calculating the start address of the loaded module, whenever such information is not available, comprising the steps:
a. notifying the host debugger that the debugged module is loaded, passing the addresses of the module init_module and cleanup_module functions, wherein the OS normally invokes said init_module function after the debugged module is loaded in memory, and further wherein the OS normally invokes said cleanup_module function before the debugged module is unloaded from memory, and whereas a module may have a selected one of one, none, or both init_module and cleanup_module functions specified;
b. responsive to module loading notification, calculating the absolute value of the start address of the in-memory program code area by offsetting the provided addresses of the init_module and cleanup_module functions from their respective relative addresses contained in the symbol table of the debugged module program image file;
c. comparing results of calculation based on each address for validation.

40. The program product of claim 39, further comprising:
a. calculating the start address using one such function address available;
b. failing to provide symbolic debugging of the module if none is available.

41. The program product of claim 37, further comprising asynchronously putting the target system under debug, comprising the steps:
a. configuring the host debugger to debug a benign module, which does nothing when loaded and unloaded;
b. loading the benign module when the target needs to be debugged;
c. unloading the benign module when resuming the target execution.

42. A program product for transferring execution flow from the debug agent exception handler to and from the debug agent command loop after the occurrence of a debugging trap, comprising:
a. prior to the debugging trap occurrence, the debug agent capturing the execution context at the destination within the debug agent command loop;
b. saving of system context at trap occurrence in the context saved area and invoking the debug agent trap handler;
c. the debug agent trap handler saving and replacing the contents of the context saved area with said captured context at the destination;
d. the debug agent trap handler executing the exception return code to resume system execution to the specified destination within the debug agent command loop, whereas said specified destination context is stored in the context saved area;
e. the debug agent responding to one or more access requests from the host debugger;
the debug agent, responsive to a run-control request, performing steps comprising:
f. setting a global variable to a value denoting transference of command loop to trap handler, whereas such variable is accessible to debug agent command loop and debug agent trap handler;
g. executing an instruction causing the system to enter exception mode, wherein said instruction is a selected one of: a BREAK instruction or an illegal instruction, further wherein the BREAK code or the illegal instruction opcode denotes transference;
h. the system invoking the debug agent trap handler on entrance to exception mode;
responsive to determining that both the value of the global variable and the break code or the illegal instruction opcode denotes transference, the debug agent trap handler resuming execution to the debugged entity, comprising the steps:
i. restoring original execution context of the debugged entity to the context saved area;
j. executing the exception return code, resuming system execution to the destination at or near the point of the debugging trap occurrence in the debugged entity.

43. The program product of claim 42, wherein the debug agent exception handler executes under system exception context and the debug agent command loop executes under system non-exception context.

44. The program product of claim 42, further comprising communicating with the remote host debugger from the debug agent command loop, comprising the steps:
a. at debug agent initialization time, establishing a socket connection to the host debugger via available networking devices on the target;
b. exchanging debugging messages with the host debugger by invoking OS kernel send and receive functions from the debug agent command loop;
wherein said network devices operate in interrupt-driven mode via the OS kernel built-in device drivers, further wherein network devices consisting: wired and wireless Ethernet, serial, firewire, parallel, and USB devices.

45. The program product of claim 42, further comprising communicating with the remote host debugger from the debug agent command loop, comprising the steps:
a. connecting a hardware-assisted debugging probe to the target computer;
b. connecting the host computer to the hardware-assisted debugging probe;
c. exchanging debugging messages by writing and reading dedicated memory regions on the target computer accessible to both the host debugger and the debug agent command loop;
wherein said hardware-assisted debugging probe consisting: JTAG emulator, or ROM emulator.
